(19) United States
(12) Patent Application Publication
(10) Pub. No.: US 2015/0227149 A1
(43) Pub. Date: Aug. 13, 2015

(54) SMART CIRCUIT BREAKER

(71) Applicant: TEJESH MAKANAWALA, Mountain View, CA (US)

(72) Inventor: TEJESH MAKANAWALA, Mountain View, CA (US)

(21) Appl. No.: 14/576,192

(22) Filed: Dec. 18, 2014

Related U.S. Application Data
(60) Provisional application No. 61/917,675, filed on Dec. 18, 2013.

(51) Int. Cl. G05F 1/66; G05B 15/02

(52) U.S. Cl. CPC G05F 1/66; G05B 15/02

(57) ABSTRACT

The inventive subject matter provides apparatus, systems, and methods in which one can use a feed search server to enable efficient, accurate retrieval, and discovery of experience feeds. Such feeds can be found within a feed database that it is operatively coupled with a feed search server where the discovered feeds best represent desired feed characteristics and metrics keeping in context user attributes.

CROSS REFERENCES

This application claims priority to the U.S. provisional application: 61/917675 filed Dec. 18, 2013. These and all other referenced extrinsic materials are incorporated herein by reference in their entirety. Where a definition or use of a term in a reference that is incorporated by reference is inconsistent or contrary to the definition of that term provided herein, the definition of that term provided herein is deemed to be controlling.

### FIELD OF THE INVENTION

The field of the present invention relates to a circuit breaker.

### BACKGROUND

The background description includes information that may be useful in understanding the present invention. It is not an admission that any of the information provided herein is prior art or relevant to the presently claimed invention, or that any publication specifically or implicitly referenced is prior art.

Circuit breakers provide an automatic switching mechanism that responds to fault conditions {e.g., overload or short circuit) by interrupting continuity of a circuit to discontinue electrical flow. Circuit breaker panels are used to protect electrical circuitry from damage due to an overcurrent condition, such as an overload, a relatively high-level short circuit, or a ground fault condition. To perform that function, circuit breaker panels include circuit breakers that typically contain a switch unit and a trip unit. The switch unit is coupled to the electrical circuitry (i.e., lines and loads) such that it can open or close the electrical path of the electrical circuitry. The switch unit includes a pair of separable contacts per phase, a pivoting contact arm per phase, an operating mechanism, and an operating handle.

In the overcurrent condition, all the pairs of separable contacts are disengaged or tripped, opening the electrical circuitry and moving the operating handle to a tripped position. When the overcurrent condition is no longer present, the circuit breaker can be reset using the operating handle such that all the pairs of separable contacts are engaged, closing the electrical circuitry.

In addition to manual overcurrent protection via the operating handle, automatic overcurrent protection is also provided via the trip unit. The trip unit, coupled to the switch unit, senses the electrical circuitry for the overcurrent condition and automatically trips the circuit breaker. When the overcurrent condition is sensed, a tripping mechanism included in the trip unit actuates the operating mechanism, thereby disengaging the first contact from the second contact for each phase. Typically, the operating handle is coupled to the operating mechanism such that when the tripping mechanism actuates the operating mechanism to separate the contacts, the operating handle also moves to the tripped position.

Switchgear and switchboard are general terms used to refer to electrical equipment including metal enclosures that house switching and interrupting devices such as fuses, circuit breakers and relays, along with associated control, instrumentation and metering devices. The enclosures also typically include devices such as bus bars, inner connections and supporting structures (referred to generally herein as “panels”) used for the distribution of electrical power. Such electrical equipment is typically maintained in a utility area of a building such as the basement of a residence or in a utility closet of a commercial establishment, or it can be maintained outside of such facilities and exposed to environmental weather conditions.

Being electro-mechanical devices, even though current circuit breakers provide overcurrent protection, they have relatively slow response time, and also require physical inspection in cases of machine or electric failure or failure of the circuit breaker itself. Such physical inspection can take from a few hours to many days before which the failure condition and reason for the same detected and analyzed before being rectified.

There is therefore a need for a circuit breaker device or architecture that enable remote diagnostics, management, and real-time analysis of the working condition of the circuit breaker as well as the machines to which it is connected to enable a significantly faster response and resolution time to faults.

All publications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

### SUMMARY OF THE INVENTION

The inventive subject matter provides a digital electronic circuit breaker that has fast response time for its monitoring/maintenance by means of remote diagnostics that is enabled through provision of Ethernet connectivity in the circuit breaker itself.

In an aspect of the present disclosure, the circuit breaker includes an Ethernet connection slot that is operatively coupled with a computing device and/or a storage device, wherein real-time operational data from the circuit breaker can be received in the computing device and/or the storage device to enable real-time or periodic or user-defined/desired analysis of the working condition of the circuit breaker and/or the machines to which the circuit breaker is operatively connected. Along with analysis of the operating/working condition, the proposed circuit breaker architecture, through the data/information sent by from its Ethernet connection can enable much quicker response time for overcurrent protection. Furthermore, being a digital electronic device, the proposed circuit breaker has a faster response time when compared with the existing circuit breakers that are electro-mechanical devices.

According to one embodiment, Ethernet connectivity of the proposed circuit breaker provides power data that can be used for remote diagnostics. According to one implementation, one or more proposed circuit breakers can be configured/installed on one or more manufacturing machines, and can be configured to, through their respective Ethernet connections transmit power data to a server/cloud/computing device/memory device/repository, wherein the data on the cloud/repository can then be continuously or at periodic/desired intervals analyzed and when needed can be downloaded on a computing device for remote diagnostics, which can be help prevent failure and reduce downtime.

According to another embodiment, power data collected through the Ethernet connectivity can include but is not limited to power, voltage, temperature, and current, among any other characteristics/properties/attributes. The voltage data can indicate AC power supply issues and can help quickly check for shorts at startup to verify the electrical connection. Power consumption data can also be used for correlating operating performance of one or more machines, enable efficient diagnostics of machine issues. Therefore, continuous monitoring and analysis of data can help with part replacement alerts, machine maintenance reminder, and machine status reports, which can also assist in pre-empting machine failures. Such data can also be used for energy management. According to another embodiment, the proposed circuit breaker can be configured to track motor performance during operation and electrical connection during startup, enable no unnecessary requirement of motor or wiring replacement. The service staff at the remote site can, through the remote data, quickly correlate machine stoppages with fluctuation in AC voltage.

Furthermore, instead of Ethernet connectivity, wireless means including but not limited to Bluetooth, zigbee, z-wave, and wifi, can also be configured in the proposed circuit breaker to enable transmission of wireless data from the circuit breaker to a remote system. Furthermore, instead of, and/or along with Ethernet, other wired means such as CAN, I2C, and USB can also be incorporated for communicating the data from the digital circuit breaker to remote devices.

According to another embodiment, the proposed circuit breaker construction is applicable to both DC as well as AC circuit breakers, and can further include breakers that are configured to adjust power from AC to DC or vice-versa.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

FIG. 1 is an exemplary architecture of the proposed circuit breaker in accordance with an embodiment of the present disclosure.

FIG. 2 is an exemplary architecture showing multiple digital circuit breakers in accordance with an embodiment of the present disclosure.

### DETAILED DESCRIPTION

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

The inventive subject matter provides a digital electronic circuit breaker that has fast response time by means of remote diagnostics that is enabled through provision of Ethernet connectivity in the circuit breaker itself.

In an aspect of the present disclosure, the digital circuit breaker includes an Ethernet connection slot that is operatively coupled with a computing device and/or a storage device, wherein real-time operational data from the circuit breaker can be received in the computing device and/or the storage device to enable real-time or periodic or user-defined/desired analysis of the working condition of the circuit breaker and/or the machines to which the circuit breaker is operatively connected. Ethernet connectivity can be provided by means of an Ethernet bridge adapter that can be connected with the Internet and can be plugged into another of the outlets such remote devices. Along with analysis of the operating/working condition, the proposed circuit breaker architecture, through the data/information sent by from its Ethernet connection can enable much quicker response time for overcurrent protection. Furthermore, being a digital electronic device, the proposed circuit breaker has a faster response time when compared with the existing circuit breakers that are electro-mechanical devices.

According to one embodiment, Ethernet connectivity of the proposed circuit breaker provides power data that can be used for remote diagnostics. According to one implementation, one or more proposed circuit breakers can be configured/installed on one or more manufacturing machines, and can be configured to, through their respective Ethernet connections transmit power data to a server/cloud/computing device/memory device/repository, wherein the data on the cloud/repository can then be continuously or at periodic/desired intervals analyzed and when needed can be downloaded on a computing device for remote diagnostics, which can be help prevent failure and reduce downtime.

According to another embodiment, power data collected through the Ethernet connectivity can include but is not limited to power, voltage, temperature, and current, among any other characteristics/properties/attributes. The voltage data can indicate AC power supply issues and can help quickly check for shorts at startup to verify the electrical connection. Power consumption data can also be used for correlating operating performance of one or more machines, enable efficient diagnostics of machine issues. Therefore, continuous monitoring and analysis of data can help with part replacement alerts, machine maintenance reminder, and machine status reports, which can also assist in pre-empting machine failures. Such data can also be used for energy management. According to another embodiment, the proposed circuit breaker can be configured to track motor performance during operation and electrical connection during startup, enable no unnecessary requirement of motor or wiring replacement. The service staff at the remote site can, through the remote data, quickly correlate machine stoppages with fluctuation in AC voltage.

Furthermore, instead of Ethernet connectivity, wireless means including but not limited to Bluetooth, zigbee, z-wave, and wifi, can also be configured in the proposed circuit breaker to enable transmission of wireless data from the circuit breaker to a remote system. Furthremore, instead of, and/or along with Ethernet, other wired means such as CAN, I2C, and USB can also be incorporated for communicating the data from the digital circuit breaker to remote devices.

According to another embodiment, the proposed circuit breaker construction is applicable to both DC as well as AC circuit breakers, and can further include breakers that are configured to adjust power from AC to DC or vice-versa.

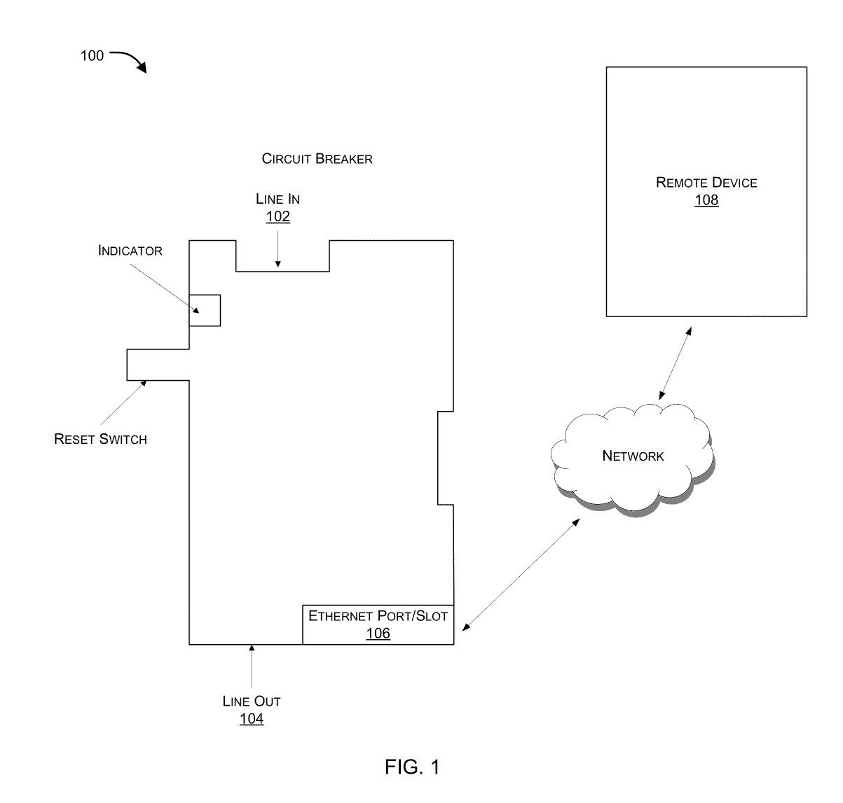

FIG. 1 illustrates an exemplary architecture of the proposed digital circuit breaker 100 in accordance with an embodiment of the present disclosure. As shown, the proposed circuit breaker 100 comprises an input 102 on top and output 104 on bottom, wherein, the circuit breaker 100 can further include a slot 106 for Ethernet connectivity that enables transmission of power/voltage/current data to a remote device 108 to enable the remote device 108 to collect and/or remotely maintain the circuit breaker 100 and/or machines operatively coupled thereto for their faults or other electrical failure indicators.

According to one embodiment, the configuration/structure of the remote device 108 can be varied depending on the desired implementation from the remote device 108. For instance, the device 108 can be cloud based server that stores the data received from the circuit breaker 100 and downloads the data onto one or more computing devices during analysis/maintenance. Device 108 can also be configured as a remote control computer or as a remote server that are operatively coupled with the circuit breaker 100 through one or a combination of firewalls, switches, routers, gateway devices, among other network-level equipments.

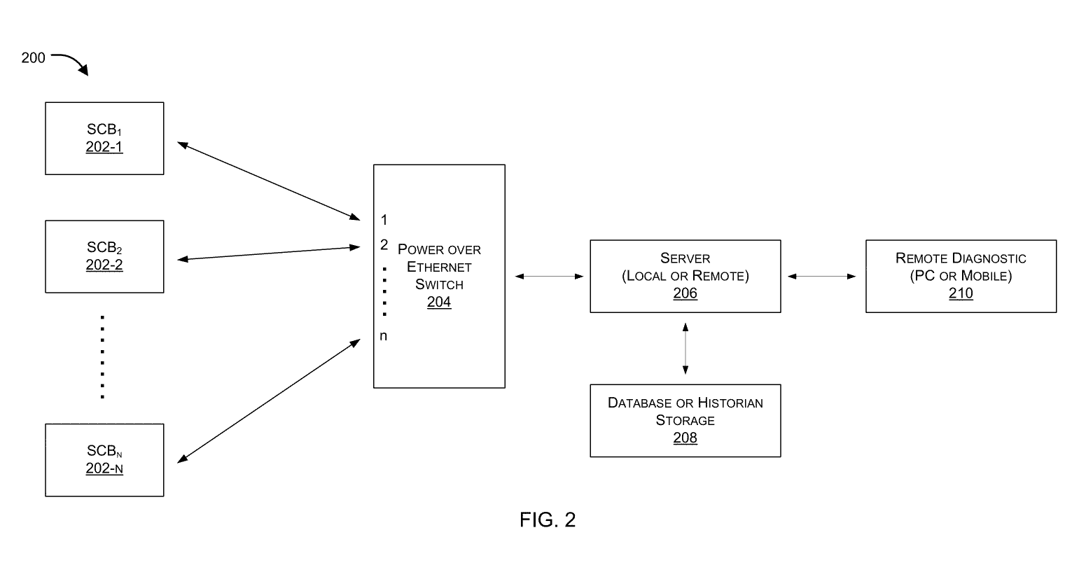

FIG. 2 illustrates an exemplary architecture 200 showing multiple digital circuit breakers 202 being operatively coupled with a Power over Ethernet (PoE) switch 204 in accordance with an embodiment of the present disclosure. As shown, one or more digital circuit breakers 202-1, 202-2, . . . , 202-n, collectively referred to as 202 hereinafter, can be operatively coupled with at least one PoE switch 204, wherein the switch can, in an exemplary implementation, be operatively coupled with a local/remote server 206. Such a server 206 can include and/or be operatively coupled with a database/repository 208, and a remote diagnostic device such as a PC or a mobile 210 that can take the power data received from one or more circuit breakers 202 and conduct remote diagnostics.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. Within the context of this document terms “coupled to” and “coupled with” are also used euphemistically to mean “communicatively coupled with” over a network, where two or more devices are able to exchange data with each other over the network, possibly via one or more intermediary device.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

While the present invention has been disclosed in connection with the presently preferred embodiments described herein, it should be understood that there may be other embodiments which fall within the spirit and scope of the invention as defined by the claims. Accordingly, no limitations are to be implied or inferred in this invention except as specifically and as explicitly set forth in the claims.

What is claimed is:

1. A circuit breaker comprising:
an input means;
an output means; and
a communication means configured to enable transmission of power data from said circuit breaker to a remote device to enable remote monitoring and maintenance of at least one of said circuit breaker and one or more machines operatively coupled with said circuit breaker.

2. The circuit breaker of claim 1, wherein said communication means is enabled through provision of an Ethernet connection slot in said circuit breaker.

3. The circuit breaker of claim 1, wherein said communication means is enabled through wireless communication means configured in said circuit breaker.

4. The circuit breaker of claim 1, wherein said communication means is enabled through one or a combination of Bluetooth, zigbee, z-wave, wifi, CAN, I2C, and USB.

5. The circuit breaker of claim 1, wherein said circuit breaker is a digital circuit breaker.

6. The circuit breaker of claim 1, wherein said circuit breaker comprises one or a combination of AC circuit breaker and DC circuit breaker.

7. The circuit breaker of claim 1, wherein said power data comprises information relating to one or a combination of power operating parameters, temperature parameters, voltage operating parameters, current operating parameters, and operating parameters of one or more machines that are operatively connected with said circuit breaker.

8. The circuit breaker of claim 1, wherein said remote device comprises one or a combination of a server, a database, a repository, and a remote computing device.
